(19) United States
(12) Patent Application Publication
(10) Pub. No.: US 2022/0273132 A1
(43) Pub. Date: Sep. 1, 2022

(54) PREPARATION OF HOT, MILK-CONTAINING BEVERAGE

(71) Applicant: FrieslandCampina Nederland B.V., Amersfoort (NL)

(72) Inventor: Wiebe Nicolaas VAN DRUTEN, Wageningen (NL)

(21) Appl. No.: 17/711,616

(22) Filed: Apr. 1, 2022

Related U.S. Application Data
(63) Continuation of application No. PCT/EP2020/077637, filed on Oct. 2, 2020.

(30) Foreign Application Priority Data
Oct. 3, 2019 (EP) 19201298.7

(51) Int. Cl. A47J 31/44; A47J 31/54; A47J 31/52; A23F 5/26

(52) U.S. Cl. CPC A47J 31/4485; A47J 31/54; A47J 31/52; A23F 5/26

(57) ABSTRACT

Process for the preparation of a hot, milk-containing beverage in a coffee machine which comprises a brewing section and a milk section, wherein the milk section comprises a liquid milk concentrate supply and a mixing device in fluid connection with the liquid milk concentrate supply. Coffee machine for executing this process.

### CROSS-REFERENCE TO RELATED APPLICATIONS

The present application is a continuation application of PCT/EP2020/077637 filed Oct. 2, 2020, which claims priority to European Patent Application No. 19201298.7 filed Oct. 3, 2019, the entire contents of which are incorporated herein by reference.

### FIELD OF THE INVENTION

The invention relates to a process for the preparation of a hot, milk-containing beverage in a coffee machine and to a coffee machine suitable for carrying out such process.

### BACKGROUND TO THE INVENTION

Coffee machines for the preparation and dispensing of different variations of hot beverages with milk, such as regular coffee with milk, cappuccino, cafe latte, latte macchiato and the like, are well known and available on the market. Various systems are available. Some systems work with reservoirs of liquid milk (particularly fresh milk or ultra high temperature-treated milk), other systems with milk powder. There are also systems that work with cartridges containing milk concentrate, whilst coffee machines that work with a, possibly replaceable, reservoir of milk concentrate have also been described. In general, systems that work with reservoirs of liquid milk or liquid milk concentrate and conduits for transporting such liquid milk or liquid milk concentrate must include good rinsing and sanitisation routines for thoroughly cleaning such reservoirs and conduits. Such routines typically mean the machine is out of duty for a shorter or longer period of time which is inconvenient, in particular when such machine is in use in e.g. restaurants or bars.

EP-1 440 910-A1 discloses a system for preparing hot beverages using cartridges which contains the beverage product that, upon contact with hot water, forms the consumable hot beverage. The cartridges are designed such that, when placed in the beverage preparation machine, hot water is passed through the cartridge and comes into contact with the beverage ingredient contained in the cartridge, after which the hot beverage is dispensed in a receptacle. The beverage product in the cartridge could be powdered, ground, leaf-based or liquid and hence could include coffee, tea, chocolate, milk or concentrated liquid milk. Any coffee or milk cartridge could have specifically designed internals, so as to create a foam layer on top of the hot beverage. Each cartridge contains a single ingredient. When, for example, a cappuccino is prepared, then a coffee cartridge is inserted into the beverage preparation machine first, the coffee is dispensed into a receptacle, the coffee cartridge is removed, the milk cartridge is inserted and the machine is operated again to dispense a milk foam layer onto the coffee. The beverage preparation machine contains a single hot water line. When preparing products that require a milk foam layer, such as cappuccinos or lattes, several acts need to be performed per serving. Particularly in a commercial catering settings such as bars and restaurants, this is not very convenient.

WO 02/100224 A2 discloses an apparatus and method for preparing a foamed beverage. According to WO 02/100224 A2 the foamed beverage is prepared from one or more concentrates, such as coffee concentrate and milk concentrate. The concentrate is mixed with hot water to prepare the hot beverage. So in case of coffee no brewing takes place, coffee is prepared by mixing coffee concentrate with hot water. Foaming is achieved by supplying air to the water before mixing with the concentrate. The water is suitably supplied under pressure, thereby drawing in the air and the resulting air/water stream is then mixed with the concentrate, thereby generating whirls and hence foaming. The apparatus contains a single water supply and water heater and may contain one or more holders for storage packs of concentrates. When preparing a hot beverage with coffee and foamed milk, coffee and milk accordingly need to be successively prepared and dispensed into a receptacle.

WO 2006/093406 A1 discloses an apparatus for preparing and dispensing a hot beverage which can be at least partly foamed. As in WO 02/100224 A2 the apparatus does not contain a brewing unit for preparing coffee, but uses coffee concentrate instead. This coffee concentrate is mixed with hot water and possibly passed through a foaming chamber. Likewise, milk concentrate could be used to prepare milk foam. The concentrates used could be in liquid or powder form. In one of the embodiments the apparatus may comprise distinct lines for coffee and milk, each line having its own hot water unit, dosing unit and foaming chamber. When in operation, hot water and concentrate are first mixed and dosed and the resulting beverage then enters the foaming chamber, where foaming takes place by whipping air into the beverage, typically by means of a stirrer. As mentioned, the apparatus disclosed does not prepare coffee by brewing but by mixing hot water with a coffee concentrate in either liquid or powder form. Consumers would generally prefer freshly brewed coffee from roasted coffee beans, if possibly freshly grinded shortly before brewing. Many of the current coffee machines, therefore, include one or more coffee bean hoppers and grinders.

EP 1 747 743 A1 discloses a coffee machine for preparing hot, milk-containing beverages, comprising a milk supply containing concentrated milk, a brewing unit, a hot water preparer and a mixing unit in fluid connection with the hot water preparer and concentrated milk supply. Concentrated milk is mixed with hot water in the mixing unit, thereby preparing hot milk which can be dispensed into a receptacle via a dedicated hot milk outlet. The coffee prepared in the brewing unit is dispensed into the receptacle via a distinct coffee outlet. The single hot water preparer in the coffee machine supplies both the brewing unit and the mixing unit with hot water. The concentrated milk supply can be a fixed reservoir that can be filled with concentrated milk or a holder for receiving a box with concentrated milk (bag-in-box system). Foaming means could be included in the apparatus too, so that air can be introduced into the hot milk stream and milk foam can be dispensed via the dedicated milk outlet. The coffee machine and corresponding method for preparing a hot, milk-containing beverage involves a single water line with a single water heater. This is not an optimum situation from an in cup-quality or process control perspective, for example, because hot water of a single temperature needs to be employed for both brewing and mixing with concentrated milk, where distinct temperatures for coffee and milk, especially milk foam, may result in better quality products. Likewise, different water pressures and water flow rates for brewing coffee and preparing milk foam lead to better end products.

US 2006/0286262 discloses an automated hot beverage dispensing machine and a method for producing hot beverages. The preferred apparatus includes a plurality of flavoring reservoirs connected through pumps and valves to a plenum that dispenses the flavoring directly into a mixing chamber. The mixing chamber also receives milk and steam, facilitating mixing of the milk, steam, and flavoring, and dispensing the mixture into a serving cup. The dispensing machine may include a coffee brewing system, whereby the machine can produce flavored lattes, cappuccinos, and the like. In the preferred embodiment, pressurized steam is directed through a Venturi assembly that draws in refrigerated milk and ambient air and delivers the fluids to a vortex mixer to produce steamed and/or foamed milk. The flavoring is delivered to the vortex mixer, and steam is channeled to the plenum to facilitate delivery of the flavoring and maintain the cleanliness of the plenum. The machine according to US 2006/0286262 has however some drawbacks with respect to process control. For example, the use of a Venturi assembly and pressurized steam makes it difficult or even impossible to deliver a constant in-cup quality.

WO 2013/128323 concerns a beverage producing machine comprising a housing, a container supporting surface, a beverage dispensing spout arranged above the container supporting surface; a coffee brewing unit arranged in the machine housing, wherein the distance between the beverage dispensing spout and the container supporting surface is adjustable. The beverage dispensing spout comprises a coffee dispensing nozzle in fluid communication with the coffee brewing unit and a milk dispensing nozzle in fluid communication with a steam generator in the housing and with a milk suction duct. The coffee dispensing nozzle and the milk dispensing nozzle are arranged one inside the other. The milk frothing device comprises or is connected to a Venturi tube.

U.S. Pat. No. 8,356,551 describes an apparatus for preparing and dispensing hot or cold milk, in the frothed or non-frothed state, in a coffee machine for preparing various types of beverages based on coffee with milk, said coffee machine comprising a coffee apparatus for producing coffee with an associated coffee dispensing device, a first water heater for producing steam, a second water heater for producing hot water for preparation of the coffee in said coffee apparatus, said first and second heaters being connected to a water source for replenishing them with water, a frothing device provided with an internal chamber for frothing the milk when required and at least one nozzle for dispensing the milk externally, said apparatus comprising a milk line for the milk, connecting a source of liquid milk to the frothing device, a steam line for the steam, connecting the first water heater to the frothing device, as well as an air line for the air, connecting a source of air to the said frothing device, a pump arranged along the milk line for supplying the milk from said source of liquid milk to said frothing device, a first intercept valve arranged along the steam line and a second intercept valve arranged along the air line, wherein said pump arranged along the milk line and said first and second intercept valves are able to be operated independently of each other such that the milk line, the steam line and the air line are connected to said chamber of the frothing device one at a time or in combination with each other.

The present invention aims to provide a process and coffee machine for preparing hot, milk-containing beverages, wherein optimum process control is combined with optimum quality products. Moreover, the present invention aims to provide a process and coffee machine for preparing hot, milk-containing beverages in a particularly efficient manner, with relatively inexpensive, durable and relatively low-energy means, while delivering an in-cup quality with a minimum of fluctuations.

### SUMMARY OF THE INVENTION

It was found that by using two separate water lines, which are independently controlled, and by using a specific mixing device, excellent results can be achieved in a coffee machine with a coffee brewing unit and a supply of liquid milk concentrate in terms of product quality (coffee, hot milk fraction and milk foam fraction), operability and process control. For the sake of clarity, the wording “separate water lines” refers to separate fluidics, i.e. the lines are separated and independently controlled from infeed until receptacle.

Accordingly, the present invention relates to a process for the preparation of a hot, milk-containing beverage by using two water streams that are independently processed and controlled: one water stream is heated and passed through a brewing section to prepare a hot beverage, whilst simultaneously or sequentially (depending of the in-cup end-recipe), a second water stream is controlled, heated and used to prepare a hot milk stream in a separate milk section by mixing the hot water with a liquid milk concentrate in a device comprising an eductor and a microfiltration device to prepare a high quality milk froth, after which the hot beverage and hot milk (or hot milk froth) are dispensed into a receptacle in the desired order and amounts.

The invention also relates to a coffee machine that is configured to carry out the above process.

An advantage of the present invention is that it allows for a modular design of the integrated coffee machine, meaning that upon maintenance and/or breakdown a very easy exchange of the milk frothing module can be achieved as the technology used in the machine is dedicated to this function. Just by releasing some fasterers an immediate exchange of the full module can be realized resulting into a very low down-time. Furthermore, the set-up of the coffee machine according to the present invention is specifically suitable for rapid consecutive preparations. With conventional machines comprising a combined heater, the second, third, fourth, etc. cup of coffee made as rapid consecutive servings are often made with water of a too high temperature, leading to coffee which is too hot or even having a burned taste, all of which is of course undesirable.

### DETAILED DESCRIPTION

The invention relates to a process for the preparation of a hot, milk-containing beverage in a coffee machine which comprises a brewing section and a milk section, wherein the milk section comprises a liquid milk concentrate supply and a mixing device in fluid connection with the liquid milk concentrate supply, said process comprising the steps of
(a) passing a first water stream into the brewing section and a second water stream into the milk section;
(b) heating the first water stream in a first water heater in the brewing section and using the resulting first hot water stream to prepare a hot beverage in the brewing section;
(c) separately, heating the second water stream in a second water heater in the milk section and mixing the resulting second hot water stream with an amount of liquid milk concentrate from the liquid milk concentrate supply in the mixing device, resulting in a hot milk stream, wherein said hot milk stream is mixed with air by introducing air into the hot milk stream via an air inlet in the mixing device resulting in a hot milk froth and wherein said mixing device comprises an eductor and a microfiltration device; and
(d) dispensing the hot beverage prepared in step (b) and the hot milk froth prepared in step (c) into a receptacle yielding the hot, milk-containing beverage.

The process of the present invention involves the use of a coffee machine that comprises a brewing section and a milk section that each have their own heater and water stream to process, thus enabling separate conditioning, regulation and control of the respective water streams. Accordingly, an important aspect of the present invention is that such brewing section and milk section operate separately and are managed and controlled separately as reflected by the presence of separate water streams entering separate water inlets, passing separate water heaters and resulting in separate hot water streams in each section. Not specifically mentioned, but also included is a system control unit with a user interface, where a user of the coffee machine can select the desired hot, milk-containing beverage, after which the system control unit, via pre-programmed routines, will execute the process of the invention inside the coffee machine. System control units with user interfaces are commonly included in coffee machines to enable a user to select the desired hot beverage.

In the brewing section of the coffee machine the preparation of a hot beverage takes place. The phrase “brewing” refers to the preparation method where hot water is passed through a layer of a solid ingredient, thereby extracting the characteristic components from such solid ingredient. The most well-known examples are passing hot water over a layer of ground coffee for preparing coffee and passing hot water over tea leaves or ground tea leaves for preparing tea. The present invention particularly concerns the preparation of coffee, although other hot beverages that can be prepared by a brewing operation are not excluded. In step (b) of the process of the invention, accordingly, the first hot water stream is suitably passed through a portion of ground coffee in the brewing section resulting in a hot coffee stream as the hot beverage. The portion of ground coffee will obviously be selected in accordance with the selection of the user, both in terms in type of coffee if different types are available, as in amount (e.g. an espresso, latte, cappuccino or regular coffee may all require different amounts of ground coffee per portion).

Typical operating conditions in the brewing section are those conventionally used in coffee machines. Yet, such conditions could vary. Coffee cakes, for examples, could be a relevant factor. Such coffee cakes could act as variable resistance in the brewer section due to the nature of the roast and ground coffee. To this end fluidics and fluidics controls in coffee machines are more and more tailored to guarantee steady downstream flowrates of the extracted (i.e. freshly brewn) coffee. Due to the resistance caused by the coffee cake in the brewer section and the desired high quality of the extracted beverage high upstream pressures may be needed, usually in the range of 6 to 12 bar. Flowrates of the liquid coffee extract after the brewing section (not taking into account the coffee foam) are typically in the range of 1 to 2.5 ml/s for a single serving of 20 to 40 ml. This may go up to approx 7 to 8 ml/s for largers servings, larger brewer dimensions (coffee cake volume) or double servings. Accordingly, flow rate of the liquid coffee extract may range from 1 to 8 ml/s depending on the size of the final serving. Typical temperature ranges of the hot water and coffee extract in the coffee machine are generally in the range of 80 to 95° C.

In the milk section a hot milk stream is prepared by mixing preselected amounts of liquid milk concentrate and hot water, the exact amounts of each being determined by the type of hot, milk-containing beverage selected by the user of the coffee machine. The liquid milk concentrate is contained in a liquid milk concentrate supply while in step (c) the hot water is prepared by passing the second water stream through the second water heater. In this second water heater the second water stream is suitably heated to a temperature in the range of 60 to 105° C., more suitably 65 to 99° C., and most suitably 90 to 98° C. This will result, in an energy efficient manner, in a hot milk stream which, when being dispensed, has a temperature of between 60 and 80° C. Before being passed into the second water heater the second water stream is suitably pressurized to a pressure of between 1.1 to 10 bar, more preferably between 1.2 and 5 bar and most preferably between 1.2 and 2.5 bar. Such pressurization will typically take place in a flow controlled water pump, compressor or watervessel with a static pressure. Flow rate of the second water stream is typically in the range of 100 to 1000 milliliters per minute (ml/min), preferably 120 to 700 ml/min, most preferably 150 to 500 ml/min. The liquid milk concentrate supply can consist of multiple containers with liquid milk concentrate, so that when one container is empty, the user can switch to a next (full) container, while the empty container is replaced by a new, full container. This allows a continuous operation. The milk section will also comprise a mixing device in fluid connection with the liquid milk concentrate supply for mixing hot water with liquid milk concentrate, thereby preparing the hot milk stream.

The mixing device may form part of the coffee machine, but for the purpose of the present invention it is preferred that the liquid milk concentrate supply and mixing device are irreleasably connected and together constitute a replaceable stock keeping unit (or SKU) for the liquid milk concentrate. Such SKU would typically comprise a container (e.g. box or bag) as the liquid milk concentrate supply and a specifically designed valve as the mixing device that can be releasably connected to a conduit for supplying hot water. The valve has an outlet for the hot milk stream which can, for example, be releasably connected to a hot milk outlet of the coffee machine. The term “replaceable stock keeping unit” or “SKU” as used herein accordingly means a container containing a stock of liquid milk concentrate which container is fluidly and irreleasably connected with a mixing device for mixing liquid milk concentrate with hot water and optionally air to produce a hot milk stream. Such SKU will suitably be disposable.

The liquid milk concentrate that can be used is suitably a concentrate based on cow's milk. In a preferred embodiment the liquid (cow's) milk concentrate has a dry matter content of 20 to 40% by weight, based on total weight of liquid milk concentrate, more preferably from 22 to 35% by weight and most preferably from 23 to 30% by weight. Fat content of the liquid milk concentrate may typically vary from 0 to 16% by weight, suitably from 0.1 to 12% by weight. The liquid milk concentrate used could also be of non-dairy origin, for instance be plant-based (such as derived from soy milk), or could be a mixture of dairy- and plant-based concentrates.

In step (c) of the process of the invention the hot milk stream is furthermore mixed with air by introducing air into the hot milk stream via an air inlet in the mixing device resulting in a hot milk froth as the hot milk stream resulting from step (c). The air is suitably pressurized and introduced into the hot milk stream via the aforesaid air inlet at a pressure that is higher than the pressure of the hot milk stream in order to enable the air to effectively enter the hot milk stream, thereby forming fine air bubbles and hence a milk froth. A pressure difference of between 0 and 15 bar, more suitably between 0 and 10 bar, was found to lead to good foaming results. Accordingly, an air pressure upon entry into the mixing device of at least 1.2 bar would be suitable, while good results have been obtained at air pressures of at least 5 bar, preferably between 7 and 15 bar. Flow rate of the air is typically in the range of 10 to 40 normal litres per hour (nL/hr), preferably 12 to 25 nL/hr. Normal litres of air per hour refers to the amount of air flowing through the pipe in question calculated at normal conditions of 0° C. and 1 atm. The amount of gas introduced in terms of hot milk stream flow rate to gas flow rate will typically be in the range of 10:1 to 1:10, in particular 5:1 to 1:5, more particularly 2:1 to 1:1.5. Pressurization of the air can be achieved by conventional gas pressurization means, such as air pumps or air compressors. Such pressurization means would typically form part of the coffee machine.

A particularly suitable SKU for use in the present invention is a disposable assembly for producing a milk froth which comprises a container containing the liquid milk concentrate which container is irreleasably connected with a mixing device comprising an eductor and a microfiltration device. The eductor and microfiltration device are suitably contained in a single housing. The eductor comprises a hot water inlet configured to receive the second hot water stream, a hot milk outlet for the hot milk stream and an inlet for liquid milk concentrate from the container which liquid milk concentrate inlet is positioned between said hot water inlet and said hot milk outlet. The hot milk outlet of the eductor is fluidly connected with a hot milk inlet of the microfiltration device. This microfiltration device further comprises an air inlet, suitably for receiving pressurized air, and an outlet for dispensing the hot milk froth. This latter outlet may be in fluid connection with a hot milk stream outlet of the coffee machine, if the coffee machine has such separate outlet. A suitable disposable assembly as described here is disclosed in WO 2014/069993 A1. The contents of WO 2014/069993 is hereby incorporated by reference.

In a preferred embodiment the mixing device comprises a microfiltration device with a tubular microfiltration wall having gas transmissive pores, said microfiltration device comprising an inlet opening and an outlet opening, said microfiltration device further comprising a housing surrounding said tubular microfiltration wall for forming a gas supply space between the tubular microfiltration wall and the housing, wherein said housing comprises a gas opening in communication with said gas inlet tuble, said tubular microfiltration wall being made of a hydrophobic material. In this manner, when the disposable assembly is operatively connected to a product preparation apparatus, liquid milk concentrate is supplied to the microfiltration device, in order to be provided with gas in a sterile manner, since the microfiltration device of hydrophobic material functions as a HEPA (High-Efficiency Particulate Air) filter, leading to a very hygienic manner of preparing the hot milk froth. In this manner, when preparing the hot, milk-containing beverage, the use of the mixing device for adding gas to the product provides a highly stable, attractive froth, in particular of constant quality, in a relatively simple manner.

In step (d) the hot beverage prepared in step (b) and the hot milk froth prepared in step (c) are dispensed into a receptacle yielding the hot, milk-containing beverage. The term “receptacle” as used herein means any receptacle suitable for holding a hot, milk-containing beverage. Typically this could be a cup, mug, glass or any other holder that can be used for consuming hot beverages.

As mentioned hereinbefore, a system control unit will typically be used to carry out pre-programmed tasks in the coffee machine in executing the process of the present invention. Hence, per serving of hot, milk-containing beverage dispensed in the receptacle at least
(i) the amount of water passed through the first water inlet and the amount of water passed through the second water inlet,
(ii) the volume ratio of second hot water stream to liquid milk concentrate used to prepare the hot milk stream,
(iii) the amount of hot beverage and the respective amounts of ground coffee and first hot water stream needed to prepare such amount of hot beverage,
(iv) the volume ratio of hot milk stream to hot beverage, and
(v) the order in which the hot milk stream and hot beverage are dispensed into the receptacle,
   are suitably controlled by a system control unit that is comprised in the coffee machine. Which tasks are performed and the order in which they are performed varies per product and hence is ultimately determined by the selection made by the user via the user interface that is connected to the system control unit and through which the system control unit receives its instructions.

As described above, an important aspect of the present invention is that brewing section and milk section are operated and controlled separately and independently. Such separate and independent operation and control would also be managed by the system processing unit. Separate operation implies that the respective water streams which are passed through the brewing section and milk section can be processed, monitored and conditioned completely independent from each other. As a result, a hot beverage and a hot milk stream of optimum quality can be prepared, thus resulting in a final hot, milk-containing beverage of excellent quality. In this connection it was found particularly useful that flow rate, pressure and temperature of the respective water streams in the brewing section and milk section can be set and controlled independent from each other. Accordingly, if pressurization and regulation of the water stream is applied in each section, each section has its own (preferably regulated) water pump and flow meter in addition to the (preferably regulated) water heater. Of course each section in addition has its own parameters to control. For example, if a milk froth is to be prepared in the milk section, air pressure of the air introduced into the hot milk stream in the mixing device of the SKU is an important parameter to control. Likewise, in the brewing section, the supply (amount, type) of coffee and timing of successive operations (dispense of coffee beans of the desired type from the coffee bean hopper into the grinder and from the grinder into the brewing unit before the hot water is passed through) are also important parameters to control.

Further additional control means can be used in the coffee machine for carrying out the process of the present invention. For example, further control means could be included to control the simultaneous power consumption of both sections. Especially with limited power supply from the grid this function helps in always ensuring the right performance of flow rates and temperatures whilst maintaining operational safety. Control means to control end temperatures of the hot beverage and hot milk stream when dispensed into the receptacle could also be used.

The invention also relates to a coffee machine for preparing a hot, milk-containing beverage and dispensing such beverage into a receptacle, said coffee machine comprising a brewing section, a milk section and a system control unit for controlling the operation of the brewing section and milk section, wherein
(a) the brewing section comprises a first water inlet, a first water heater, coffee supply means, a brewing unit and a hot beverage outlet, wherein
   the first water inlet is fluidly connected to the first water heater,
   the first water heater and the brewing unit are fluidly connected,
   the coffee supply means are fluidly connected to the brewing unit and
   the hot beverage outlet is fluidly connected to the brewing unit; and
(b) the milk section comprises a second water inlet, a second water heater, at least one holder for receiving a replaceable stock keeping unit of liquid milk concentrate and outlet means for a hot milk stream, wherein
   the second water inlet is, preferably via a regulated waterpump to precisely control the waterflow rate, fluidly connected to the second water heater,
   the second water heater is fluidly connected to the holder via a hot water conduit,
   the holder comprises means for releasably connecting the hot water conduit to the water inlet of a replaceable stock keeping unit (SKU) of liquid milk concentrate when placed in the holder, and
   the holder comprises means for releasably connecting the outlet means for a hot milk stream with the outlet of a replaceable stock keeping unit of liquid milk concentrate when placed in the holder, and
   wherein the milk section further comprises an air inlet and means for releasably connecting the air inlet to the replaceable stock keeping unit of liquid milk concentrate when contained in the holder.

The milk section comprises means for releasably connecting the air inlet to the replaceable (or disposable) SKU of liquid milk concentrate when contained in the holder, and more specifically to the air inlet of the mixing device that forms an irreleasable and integral part of the SKU. As described above, a preferred disposable SKU is disclosed in WO 2014/069993 A1.

The coffee machine of the invention also comprises a system control unit. Such system control unit is suitably programmed to control per serving of hot, milk-containing beverage dispensed into the receptacle at least
(i) the amount of water passed through the first water inlet and the amount of water passed through second water inlet,
(ii) the volume ratio of second hot water stream to liquid milk concentrate used to prepare the hot milk stream,
(iii) the amount of hot beverage and the respective amounts of the portion of ground coffee and first hot water stream needed to prepare such amount of hot beverage,
(iv) the volume ratio of hot milk stream and hot beverage, and
(v) the order in which the hot milk stream and hot beverage are dispensed into the receptacle.

Other parameters and settings may be controlled too by the system control unit. For example, the system control system may be provided with a power consumption controller that regulates power consumption of either section (including water heater) to ensure safe operation and to eliminate inertia from the heaters that in the end can create malperformance of a section. Further examples of parameters to be controlled by the system control unit are the different temperature, pressure and flow rate settings. The system control unit can also be used to manage machine read outs (e.g. format, datasets) and usage of data, including remote exchange of operating data.

The system control unit executes the pre-programmed tasks in accordance with the selection of a hot beverage made by the user via a user interface. A system control unit will typically comprise a microprocessor that execute the functions as programmed in the underlying operating software in accordance with the user instructions given. This software provides the machine instructions to the microprocessor for executing the different tasks in the coffee machine along the lines of the process of the present invention as described above.

The coffee machine of the invention will also comprise the necessary auxiliary and metering equipment, such as pumps, compressors, filters, flow meters, valves, valve blocks, a coffee cake tray collector and a drip tray. If roasted coffee beans are used instead of powdered filter coffee, then the coffee machine will also contain means for storing roasted coffee beans, such as one or more bean hoppers, as well as one or more grinders to grind the beans and product ground coffee for the brewing unit.

### DESCRIPTION OF FIGURES

FIG. 1 shows an exemplary flow scheme of a coffee machine for carrying out the process of the present invention.

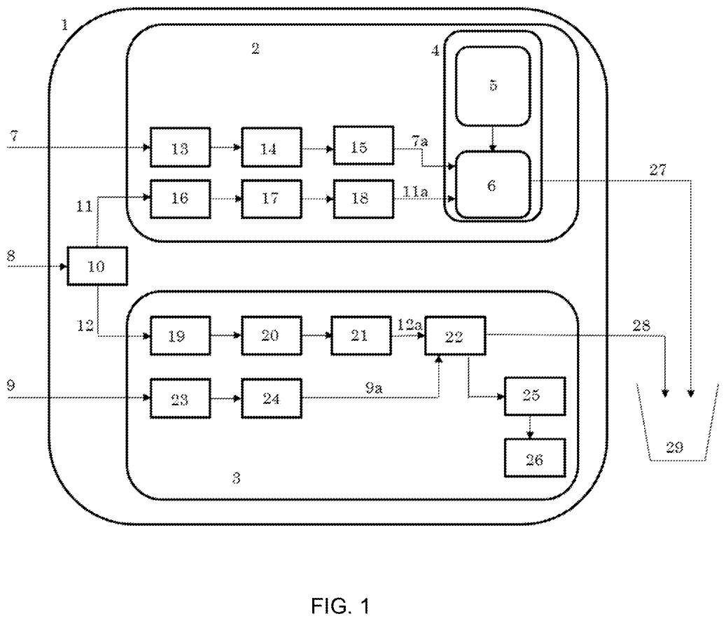

In FIG. 1 the coffee machine 1 comprises a milk section 2 and a brewing section 3. Water stream 8 enters the coffee machine 1 and passes through valve 10 where it is split into a first water stream 12 and a second water stream 11. The first water stream 12 enters brewing section 3 and successively passes water pump 19, water flow meter 20 and first water heater 21 resulting in first hot water stream 12a. Bean hopper 23 that forms part of brewing section 3 is fed with coffee bean supply 9. The coffee beans from bean hopper 23 are ground in grinder 24 and ground coffee 9a is passed into brewing unit 22. The first hot water stream 12a is also passed into brewing unit 22, where coffee 28 is prepared. Meanwhile, the second water stream 11 enters the milk section 2 and successively passes water pump 16, water flow meter 17 and second water heater 18 resulting in second hot water stream 11a that enters mixing device 6 of SKU 4. In the flow scheme of FIG. 1 an air stream 17 enters the coffee machine 1 in milk section 2 and after passing through particle filter 13 it is pressurized in air pump 14, after which the pressurized air 7a enters the mixing device 6 of SKU 4 via air sealed connector 15 that ensures a releasable, air tight connection with mixing device 6. Liquid milk concentrate from liquid milk concentrate supply 5 enters the mixing device 6. In mixing device 6 the liquid milk concentrate is first mixed with the second hot water stream 11a resulting in a hot milk stream before pressurized air 7a is introduced in this hot milk stream resulting in milk froth 27. Coffee 28 and milk froth 27 are eventually dispensed in receptacle 29. The coffee cake resulting from brewing coffee in brewing unit 22 is collected in cake tray 25 whilst any water contained in the cake is collected in drip tray 26.

1. A process for the preparation of a hot, milk-containing beverage in a coffee machine, which comprises:
(i) a brewing section,
(ii) a milk section, wherein the milk section comprises a liquid milk concentrate supply, and
(iii) a mixing device comprising an eductor and a microfiltration device, where the mixing device is in fluid connection with the liquid milk concentrate supply, the process comprising:
(a) passing a first water stream into the brewing section and a second water stream into the milk section;
(b) heating the first water stream in a first water heater in the brewing section and using the resulting first hot water stream to prepare a hot beverage in the brewing section;
(c) heating the second water stream in a second water heater in the milk section and mixing the resulting second hot water stream with an amount of liquid milk concentrate from the liquid milk concentrate supply in the mixing device, resulting in a hot milk stream,
(d) mixing the hot milk stream with air by introducing air into the hot milk stream via an air inlet in the mixing device resulting in a hot milk froth; and
(e) dispensing the hot beverage of (b) and the hot milk froth from (d) into a receptacle yielding the hot, milk-containing beverage.

2. The process according to claim 1, wherein the liquid milk concentrate supply and mixing device are irreleasably connected and together constitute a replaceable stock keeping unit for the liquid milk concentrate.

3. The process according to claim 1, wherein in (b), the first hot water stream is passed through a portion of ground coffee in a brewing unit resulting in a hot coffee stream as the hot beverage.

4. The process according to claim 1, wherein per serving of hot, milk-containing beverage dispensed in the receptacle, a system control unit comprised in the coffee machine, controls at least one of:
(i) the amount of water passed through the first water inlet and the amount and flowrate of water passed through the second water inlet,
(ii) the volume ratio of second hot water stream to liquid milk concentrate used to prepare the hot milk stream,
(iii) the amount of hot beverage and the respective amounts of ground coffee and first hot water stream needed to prepare such amount of hot beverage,
(iv) the volume ratio of hot milk stream to hot beverage, and
(v) the order in which the hot milk stream and hot beverage are dispensed into the receptacle.

5. A coffee machine for preparing a hot, milk-containing beverage, comprising:
(a) a brewing section, comprising a first water inlet, a first water heater, coffee supply, a brewing unit and a hot beverage outlet, wherein
(i) the first water inlet is fluidly connected to the first water heater,
(ii) the first water heater and the brewing unit are fluidly connected,
(iii) the coffee supply means are fluidly connected to the brewing unit, and
(iv) the hot beverage outlet is fluidly connected to the brewing unit;
(b) a milk section, comprising a second water inlet, a second water heater, at least one holder for receiving a replaceable stock keeping unit of liquid milk concentrate and an outlet for a hot milk stream, wherein:
(i) the second water inlet is fluidly connected to the second water heater,
(ii) the second water heater is fluidly connected to the holder via a hot water conduit,
(iii) the holder comprises a first releasable connector connecting the hot water conduit to the water inlet of a replaceable stock keeping unit of liquid milk concentrate when placed in the holder, and
(iv) the holder comprises a second releasable connector for connecting the outlet means for a hot milk froth with the outlet of a replaceable stock keeping unit of liquid milk concentrate when placed in the holder, and
wherein the milk section further comprises an air inlet and a third releasable connector for connecting the air inlet to the replaceable stock keeping unit of liquid milk concentrate when contained in the holder, and
(c) a system control unit for controlling the operation of the brewing section and milk section.

6. The coffee machine according to claim 5, wherein the system control unit is programmed to control, per serving of hot, milk-containing beverage dispensed into the receptacle, at least one of:
(i) the amount of water passed through the first water inlet and the amount of water passed through second water inlet,
(ii) the volume ratio of liquid milk concentrate to second hot water stream used to prepare the hot milk stream,
(iii) the amount of hot beverage and the respective amounts of the portion of ground coffee and first hot water stream needed to prepare such amount of hot beverage,
(iv) the volume ratio of hot milk stream and hot beverage, and
(v) the order in which the hot milk stream and hot beverage are dispensed into the receptacle.
